(19) United States
(12) Patent Application Publication
(10) Pub. No.: US 2011/0101051 A1
(43) Pub. Date: May 5, 2011

(54) INFANT CARRIER WITH LEG STRAPS

(76) Inventors: MICHAEL A. PARNESS, Solana Beach, CA (US); Sara Lighthall, San Diego, CA (US); Melissa Ward, Santee, CA (US)

(21) Appl. No.: 12/917,671

(22) Filed: Nov. 2, 2010

Related U.S. Application Data
(60) Provisional application No. 61/257,404, filed on Nov. 2, 2009.

(51) Int. Cl. A61G 1/00

(52) U.S. Cl. 224/160

(57) ABSTRACT

An infant carrying apparatus is provided. The apparatus includes a primary support panel having a top end, an opposed bottom end, and a midsection. Additionally, there is a pair of shoulder harnesses that are fixed to the top end of the primary support panel. Attached to each opposed side of the midsection of the primary support panel are leg supports, which are engageable to a respective one of the shoulder harnesses.

### CROSS-REFERENCE TO RELATED APPLICATIONS

This application claims the benefit of U.S. Provisional Application No. 61/257,404, filed Nov. 2, 2009.

### STATEMENT RE: FEDERALLY SPONSORED RESEARCH/DEVELOPMENT

Not Applicable

### BACKGROUND OF THE INVENTION

1. Technical Field of the Invention

The present disclosure relates generally to carrying and support devices. More particularly, the present disclosure relates to shoulder harness devices for on-the-body carry of infants and small children. Additionally, the present disclosure relates to infant carriers with leg straps.

2. Description of the Related Art

It is common practice for parents and other caregivers to carry infants and toddlers, and there is a variety of well-known devices suitable to this end. Such infant-carrying devices include carriages, strollers, pushchairs, and car seats, which are separate units particularly configured for holding the infant or toddler independent of the parent/caregiver adult. The adult, in turn, holds and transports the device with handles and other attachments thereof. Alternatively, there are devices known in the art configured to be worn by the adult for on-the-body carrying of the infant or toddler, including slings, wraps, pouches, and backpack-like shoulder strap devices.

Historically, the practice of carrying infants and toddlers on the body of the parent/caregiver is more prevalent in traditional cultures, and indeed, most basic slings and wraps are derivations of long-established designs originating therefrom. In industrialized cultures, however, it was deemed to be detrimental to the development of the child to experience too much physical contact with the parents or caregivers. Thus, carrying infants and toddlers in a manner that would entail the same was, and remains, relatively uncommon. However, these views are increasingly being challenged on the basis that there are numerous developmental benefits to the child. Additionally, there are immediate benefits to the parent/caregiver, including the freedom to use both hands while monitoring and caring for the child being carried. Thus, care may be provided to other children simultaneously, strain and fatigue on the arms, back, and shoulders may be reduced, and household chores may be completed while monitoring the child. Moreover, cumbersome and bulky strollers need not be deployed in potentially dangerous places such as crowded city sidewalks and public transportation systems. Therefore, on-the-body carrying of children is growing in popularity.

As noted, there are a number of basic configurations for infant carriers suitable for on-the-body carry, including slings, wraps, and shoulder strap carriers. Though simpler in construction, slings and wraps are not as popular as infant carriers that incorporate shoulder straps, due in part to the difficulty associated with proper wear. Among infant carriers with shoulder straps, there are those with frames fashioned after conventional backpacks. Accordingly, such framed carriers typically support the child on the back of the wearer. Also, there are frameless or soft-sided carriers that support the child on the front or chest of the wearer such as that contemplated in U.S. Pat. No. 6,763,983 to Norman, as well as those that support the child on the hip of the wearer such as that contemplated in U.S. Pat. No. 5,813,580 to Fair.

There are a number of positions and orientations in which the child may be carried, each being appropriate for different circumstances. For example, where there is a need for increased monitoring, the child may be carried on the front of, and facing backwards to, the parent or caregiver. Further, while frolicking about, completing errands, or otherwise participating in activities that takes the child out of the home, a greater degree of interaction with the surrounding environment may be offered by carrying the child in the front of, and facing forward along the same perspective as, the parent or caregiver. Where there is a significant potential for exposing the child to frontal hazards, it may be more appropriate to carry the child on the back, such that the body of the parent/caregiver acts as a shield. Conventional infant carriers incorporate features that accommodate both modes of carry.

Providing proper support for the carried child is an important design consideration in light of a typical child's diminutive size and frailty. If accidentally dropped from a normal operating height with the carrier being worn by an average adult, the child may be significantly injured. As an expression of this concern for safety, various standards are promulgated by governmental entities, international industry organizations, and the like, and manufacturers of infant carriers and other child-oriented devices develop products that conform thereto.

Accordingly, there is a need in the art for infant carrying devices with enhanced safety features. The present invention addresses this particular need, as will be discussed in more detail below.

### BRIEF SUMMARY OF THE INVENTION

In accordance with one embodiment of the present invention, an infant carrying apparatus is provided. The apparatus may include a support panel having a top end portion, an opposed bottom end portion, and a midsection disposed between the top end portion and the bottom end portion, wherein the midsection defines a pair of opposed midsection side portions. Additionally, there may be a pair of shoulder harnesses that are coupled to the top end portion of the support panel. There may also be a pair of lateral infant restraints, wherein each lateral infant restraint extends between a respective one of the pair of midsection side portions and a respective one of the pair of shoulder harnesses. The support panel, the pair of shoulder harnesses and the pair of lateral infant restraints collectively define a pair of leg openings sized and configured to receive respective ones of the legs of the infant.

Each lateral infant restraint may include a padded leg support coupled to the support panel and an adjustable connector strap connectable to the padded leg support and connected to a respective one of the pair of shoulder harnesses. The infant carrying apparatus may further include a pair of first connector elements and a pair of second connector elements. Each first connector element is coupled to a respective padded leg support, and each second connector element is coupled to a respective adjustable connector strap. Each second connector element is configured to be detachably engageable with a respective one of the pair of first connector elements to couple the respective padded leg support to the respective adjustable connector strap. The padded leg supports may include a leg support pocket sized to receive the first connector element.

The support panel may include a primary support panel including the top end portion, opposed bottom end portion and the midsection, and a secondary support panel fixed to the bottom end portion of the primary support panel. Each shoulder harness may be coupled to the secondary support panel. The infant carrying apparatus may additionally include a support belt extended through the secondary support panel, the support belt defining a first connector end engageable to an opposed second connector end to maintain a looped configuration.

The preset invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a front plan view of an infant carrier with shoulder harness and a primary support panel in accordance with one embodiment of the present invention;

FIG. 2 is a rear plan view of the infant carrier;

FIG. 3 is a detailed rear plan view of the infant carrier illustrating the shoulder harness and a leg support with an auxiliary leg strap disengaged from primary support panel;

FIG. 4A is a detailed plan view of a male buckle of the auxiliary leg strap partially engaged to a female buckle of the primary support panel;

FIG. 4B is a detailed plan view of the male buckle of the auxiliary leg strap engaged to the female buckle of the primary support panel;

FIG. 5A is a side view of the shoulder harness in a fully extended position;

FIG. 5B is a side view of the shoulder harness in a fully retracted position;

FIG. 6 is a detailed front plan view of the infant carrier showing a harness support member extending between the two shoulder harnesses; and

FIG. 7 is a detailed front plan view of the infant carrier showing a secondary support panel and a support belt.

Common reference numerals are used throughout the drawings and the detailed description to indicate the same elements.

### DETAILED DESCRIPTION OF THE INVENTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

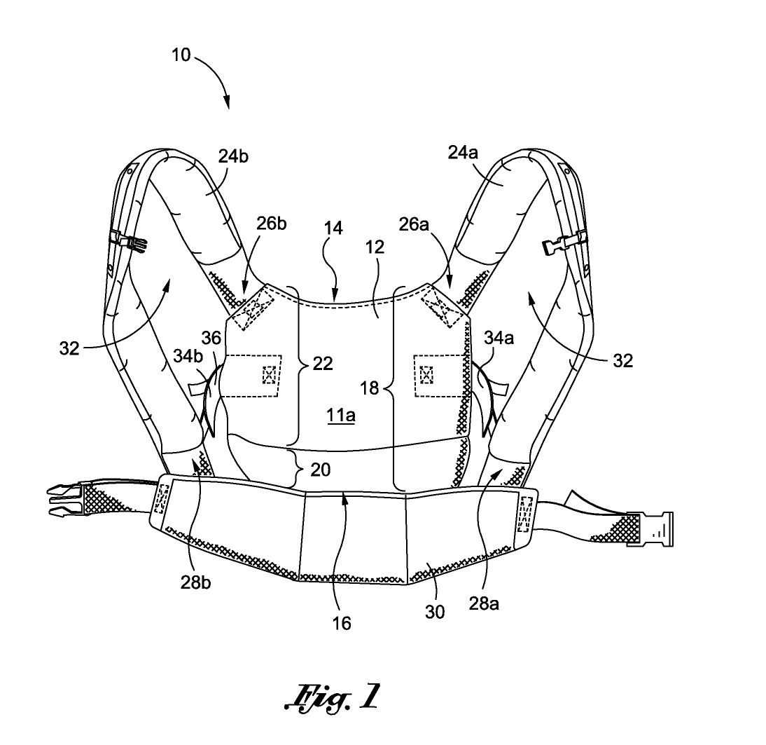

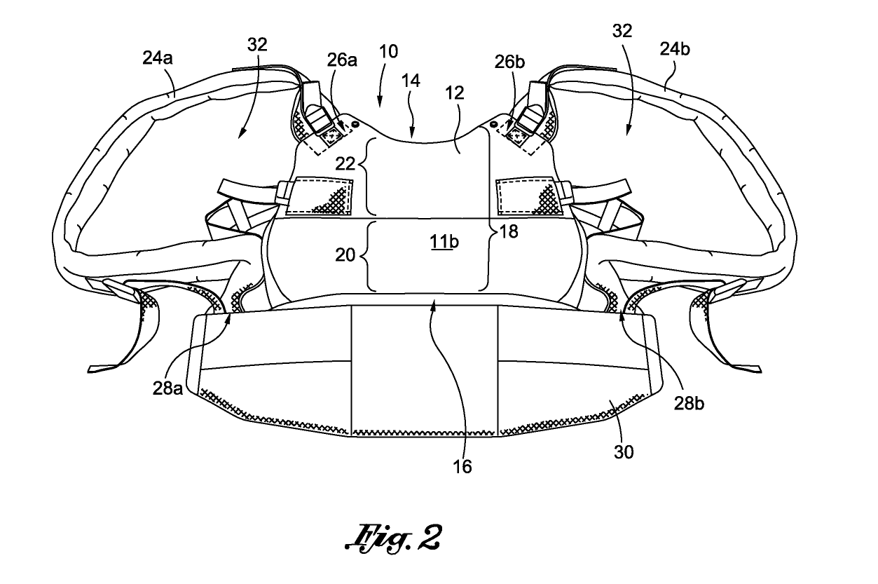

FIGS. 1 and 2 generally depict an infant carrier 10 in accordance with one embodiment of the present invention, with FIG. 1 showing an infant support side 11a and FIG. 2 showing an exposed side 11b. The infant carrier 10 is worn by a parent or other adult caregiver during normal use. The wearer is understood to be capable of bearing the weight of an infant and to have torso dimensions that can be accommodated by the various components of the infant carrier 10. As will be described in further detail below, such components are adjustable so that the infant carrier 10 may be worn by a wide variety of body sizes and types. Along these lines, the infant carrier 10 may be worn on the back of the caregiver, also referred to as the back carry configuration, as well as on the chest/abdomen of the caregiver, also referred to as the front carry configuration.

While specific reference will be made to the infant, this is by way of exemplary simplification only, and not of limitation. It is contemplated that the infant carrier 10 supports small children from newborns to toddlers. Thus, when referring to the infant carrier 10, it is understood that such nomenclature does not limit the carrying capabilities strictly to infants, i.e., children about a year old. The particular age of the occupant is inconsequential, and various embodiments of the infant carrier 10 can safely support occupants of up to 36 lbs.

As best illustrated in FIG. 1, the infant carrier 10 includes a primary support panel 12 that is defined by a top end portion 14, an opposed bottom end portion 16, and a midsection 18 between the top end portion 14 and the bottom end portion 16. The midsection 18 of the primary support panel 12 is further defined by a posterior support panel section 20 and a torso support panel section 22. A proper positioning of the occupant in the infant carrier 10 contemplates the buttocks being supported by the posterior support panel section 20. Because the posterior support panel section 20 bears a substantial portion of the weight of the occupant, in addition to cushioning material, a semi-rigid frame or backing material is included. The torso support panel section 22, on the other hand, has minimal rigidity in order to conform to the shape of the occupant, and includes some cushioning material. In general, the infant support side 11a is constructed of a non-abrasive fabric material, such as cotton, while the exposed side 11b is constructed of a resilient material such as canvas or ballistic nylon.

The infant carrier 10 also includes a pair of shoulder harnesses 24 that can be fitted over the caregiver's arms and shoulders. Specifically, there is a first shoulder harness 24a having a top end 26a fixed to the top end 14 of the primary support panel 12, and a second shoulder harness 24b likewise having a top end 26b fixed to the top end 14 of the primary support panel 12. It will be appreciated by those having ordinary skill in the art that any one of well-known stitching techniques may be utilized to secure the shoulder harnesses 24 to the primary support panel 12. In light of the safety needs associated with infant carriers, part of the fabric of the shoulder harnesses 24 may be embedded within the primary support panel 12 between the infant support side 11a and the exposed side 11b, with an outline of the embedded portion being stitched to increase seam strength and reduce the possibility of the shoulder harnessed 24 becoming detached. It is envisioned that the seam is capable of supporting at least the maximum rated occupant weight noted above, though to provide an additional margin of safety, it is capable of supporting more.

As will be described in greater detail below, the bottom end portion 16 of the primary support panel 12 is attached to, and is contiguous with, a secondary support panel 30. Additionally, the bottom ends 28a, 28b of the first and second shoulder harnesses 24a, 24b, respectively, are also attached to the secondary support panel 30. It is understood that the secondary support panel 30 encircles the waist of the caregiver. The shoulder harnesses 24, the primary support panel 12, and the secondary support panel 30 accordingly defines a primary loop 32, through which the arms of the caregiver are positioned during use.

In accordance with various embodiments, the infant carrier 10 also includes leg supports 34. More particularly, a first leg support 34a is attached to the first side, torso support section 22 of the primary support panel 12 and a second leg support 34b is attached to the second side, torso support section 22 of the primary support panel 12. FIG. 3 shows a more detailed view of the first leg support 34a, and it will be appreciated that the following description is also applicable to the second leg support 34b. The leg support 34 is understood to have an interior side 36 that is generally contiguous with the infant support side 11a of the primary support panel 12, as well as an exterior side 37 that is generally contiguous with the exposed side 11b of the primary support panel 12. As contemplated for the attachment of the shoulder harnesses 24, the leg support 34 may likewise be embedded within the primary support panel 12 between the infant support side 11a and the exposed side 11b, with stitching that outlines the embedded portion.

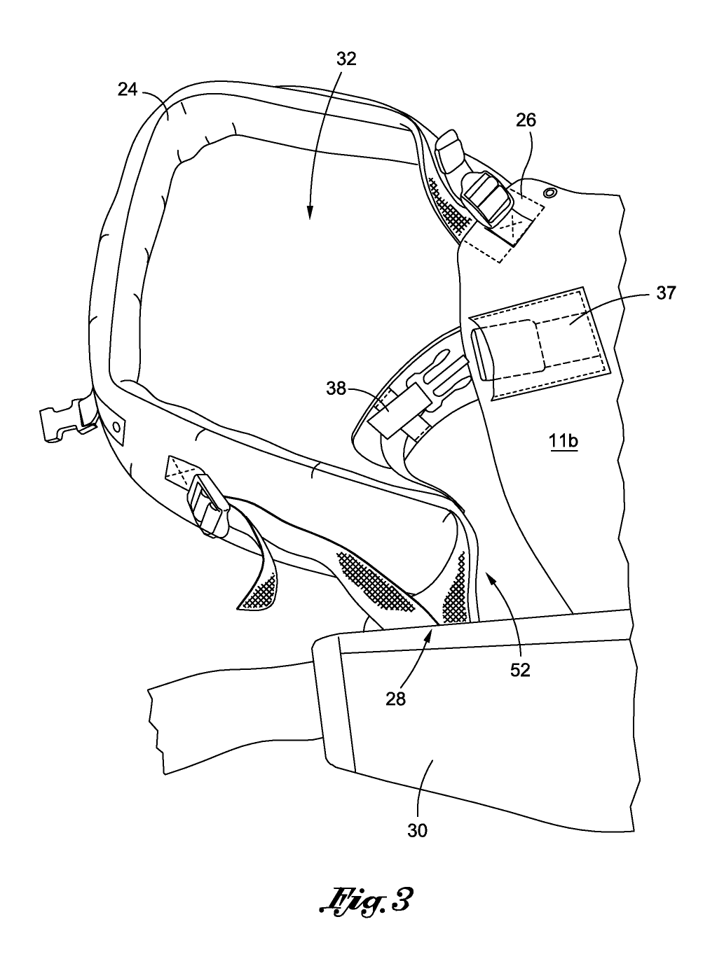

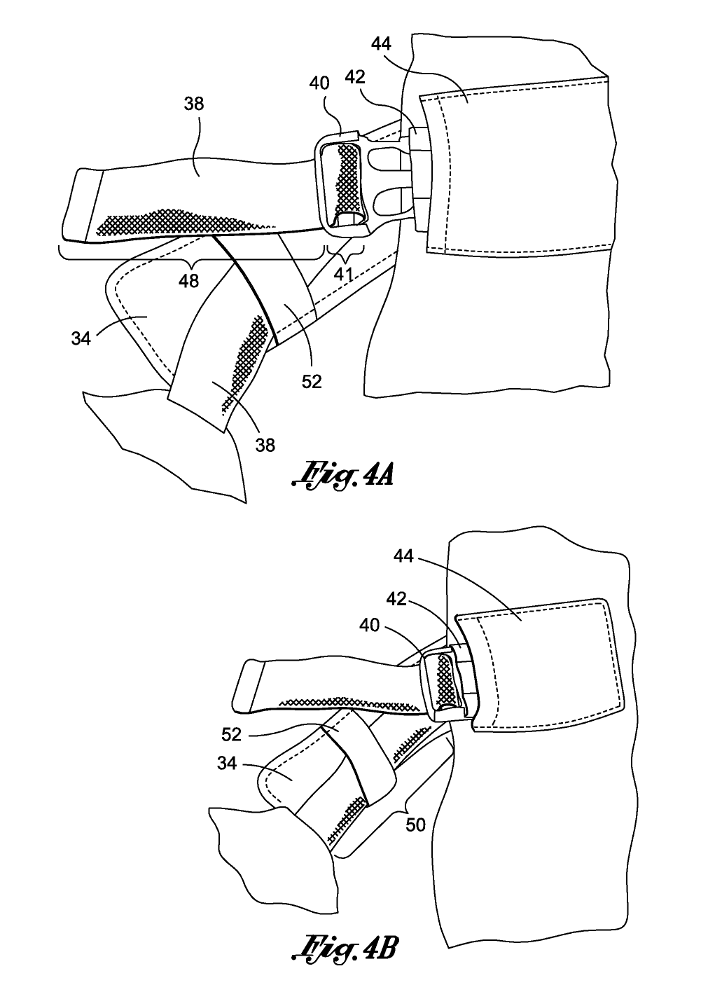

The leg support 34 is linked to the shoulder harness 24 via an adjustable connecting strap 38. As more fully illustrated in FIGS. 4A and 4B, the connecting strap 38 is fixed to the shoulder harness 24 in a perpendicular relation thereto. Furthermore, the connecting strap 38 is threaded through a male buckle element 40 that is engageable to a female buckle element 42 that is embedded within a leg support pocket 44. Although any suitable buckle may be utilized, according to the illustrated embodiment, the male buckle element 40 includes flexible members that can be inserted into the female buckle element 42 for retention therein. FIG. 4A best illustrates the male buckle element 40 being partially inserted into the female buckle element 42. The flexible members are understood to include rigid portions that abut against a corresponding rigid portion of the female buckle element 42 when engaged, preventing the male buckle element 40 from being withdrawn from the female buckle element 42. FIG. 4B best illustrates the male buckle element 40 being fully engaged to the female buckle element 42. Repositioning the rigid portion by, for example, pushing the flexible members inwards, such that it is no longer in engagement with the rigid portion of the female buckle element 42 permits the male buckle element 40 to be withdrawn.

As noted above, the connecting strap 38 is threaded through the male buckle element 40. Specifically, the male buckle element 40 includes a loop section 46. By varying a slack length 48 of the connecting strap, a corresponding leg support length 50 may be adjusted. The connecting strap 38 is passed through a retention band 52 so that it is routed generally along the same axis as the leg support 34. With reference to FIG. 3, the primary support panel 12, the leg support 34, the shoulder harness 24, and the secondary support panel 30 defines an occupant leg loop 52, through which a leg of the occupant is inserted. In this regard, the leg support 34 is understood to brace the hip region of the occupant and to properly support the occupant's leg. Along these lines, it is contemplated that the leg support 34 is padded and covered with an appropriate non-abrasive fabric such as the same type utilized for the infant support side 11a of the primary support panel 12. With the size of the occupant leg loop 52 being adjustable via the connecting strap 37, occupants with varying leg sizes and shapes can be accommodated.

With reference again to FIG. 3, it is contemplated that the occupant's arms are positioned through the primary loop 32, between the wearer's back and chest (depending on a front carry configuration or a back carry configuration), and above the leg support 34. Accordingly, as best illustrated in FIG. 4B, the leg support 34 is angled downward relative to the edge of the primary support panel 12 to provide additional clearance for the occupant's arms.

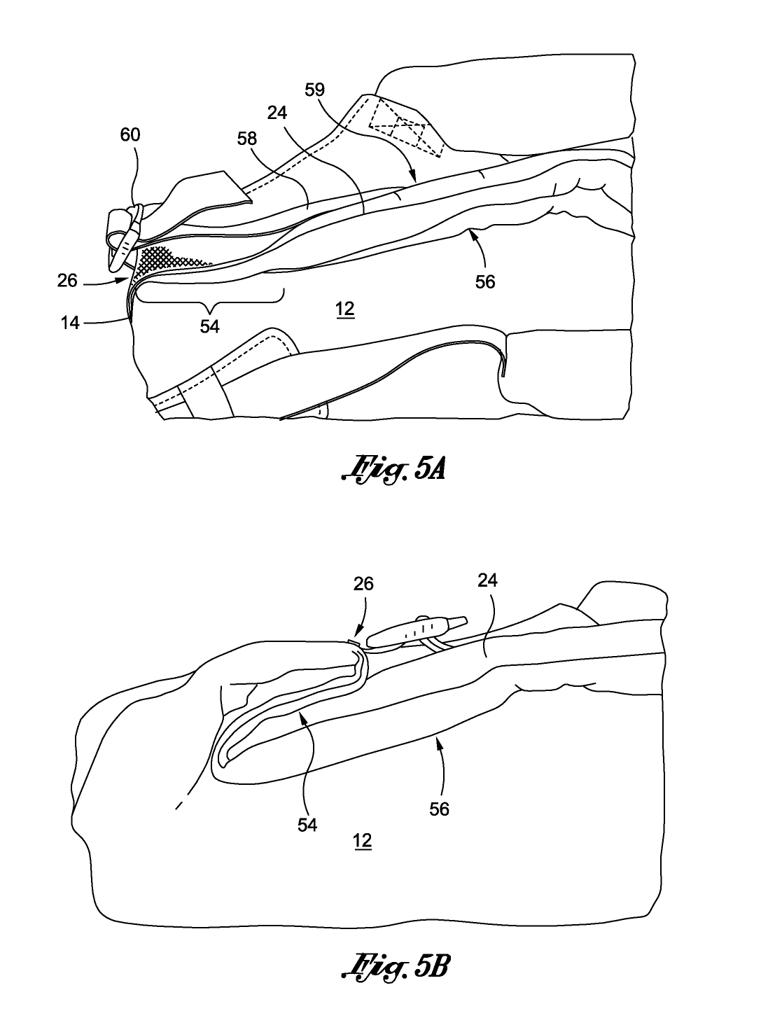

Referring now the FIGS. 5A and 5B, additional adjustment features of the shoulder harness 24 will now be described. As indicated above, the top end 26 of the shoulder harness 24 is fixed to the top end portion 14 of the primary support panel 12. In further detail, the shoulder harness 24 is defined by a flexible end portion 54 and a padded middle portion 56. The length of the flexible end portion 54, and hence the overall length of the shoulder harness 24 between its attachment points, is adjustable.

In accordance with one embodiment, an adjustment strap 58 is provided. The adjustment strap defines a bottom end 59 that is fixed to the middle portion 56 of the shoulder harness 24, and is threaded through an adjustment buckle 60. The adjustment buckle 60 is fixed to the top end portion 14 of the primary support panel 12. By increasing or decreasing the amount of slack in the adjustment strap 58, the distance between the attachment points thereof, i.e., the top end portion 14 of the primary support panel 12 and the shoulder harness 24 can be changed. FIG. 5A best illustrates the flexible end portion 54 of the shoulder harness 24 in a fully extended position in which the slack of the adjustment strap 58 is minimized, while FIG. 5B best illustrates the flexible end portion 54 being folded beneath the primary support panel 12 in a fully retracted position.

Although the adjustability feature of the shoulder harness 24 has been described in relation to its upper portion, it is also contemplated that similar adjustments made with similar components in the bottom portion are also possible. In this regard, various adjustments to both the upper and lower parts of the shoulder harness 24 may be made to position comfortably the middle portion 56. As noted above, the middle portion 56 of the shoulder harness 24 is padded; with proper positioning, pressure points on the wearer's back, chest and shoulders can be minimized.

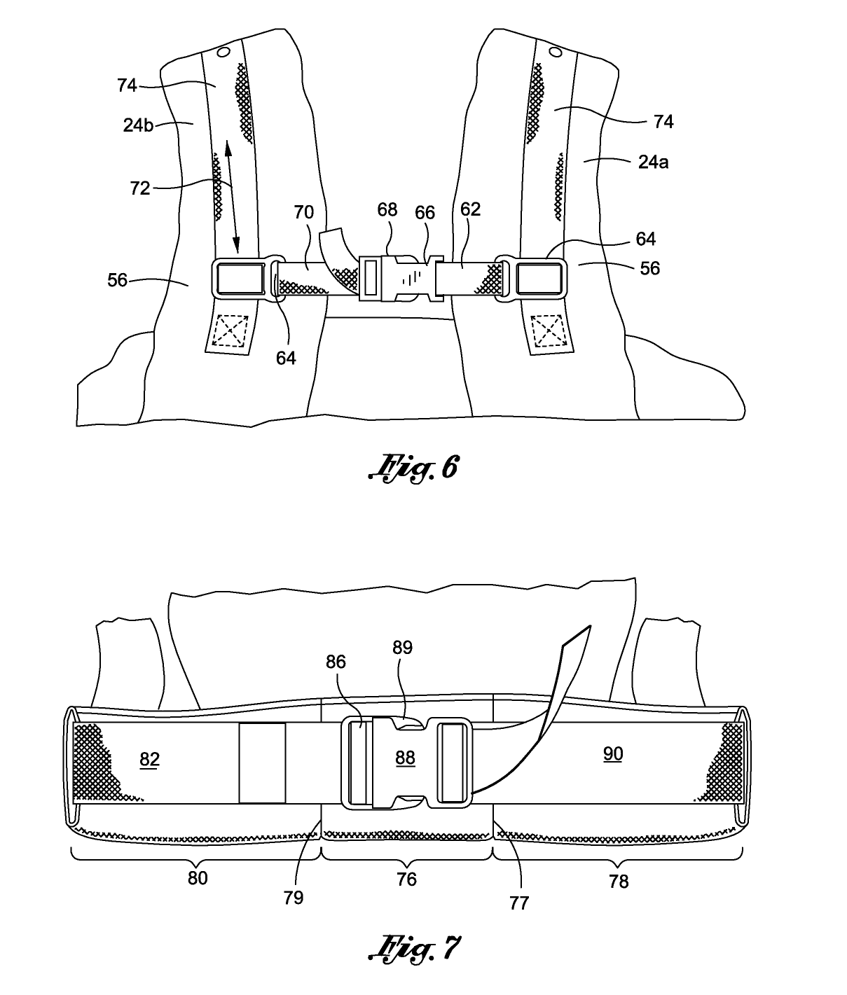

With reference to FIG. 6, the infant carrier 10 is further secured to the wearer by locking first and second shoulder harnesses 24a, 24b in place such that it does not shift about the wearer's shoulder. In particular, the first shoulder harness 24a includes a primary strap 62 that is attached to a positioner buckle 64. Additionally, the primary strap 62 is attached to a female buckle element 66 that is receptive to a corresponding male buckle element 68 associated with the second shoulder harness 24b. The female buckle element 66 and the male buckle element 68 function in the same manner as the similar named components utilized in connection with the leg support 34, above, in which the male buckle element 68 is removably engageable to the female buckle element 66 in an interlocking relationship.

Attached to the male buckle element 68 is a secondary strap 70 that is also attached to the second shoulder harness 24b. As with the other adjustment-related straps described above, the secondary strap 70 is threaded through an adjustment loop, and by extension or retraction, the length between the positioner buckle 64 and the make buckle element 68 can be adjusted. Along these lines, it is understood that while the primary strap 62 is not adjustable in the illustrated embodiment, it is possible for it to be threaded through a similar adjustment loop.

The respective one of the positioner buckles 64 associated with the first and second shoulder harnesses 24a, 24b permit the entire assembly of the primary strap 62, the female buckle element 66, the male buckle element 68, and the secondary strap 70 to be moved along the longitudinal axis 72 of the shoulder harnesses 24. Specifically, opposed ends of a positioner strap 74 are attached to the shoulder harnesses 24, such that the positioner buckles 64 can be shifted about its loose center portion.

As indicated above, the secondary support panel 30 is understood to encircle or wrap partially around the wearer during use. Generally, the secondary support panel 30 is segregated into a central pad 76, a first auxiliary pad 78, and a second auxiliary pad 80. Between the central pad 76 and the first auxiliary pad 78 there is a first seam 77, and between the central pad 76 and the second auxiliary pad 80 there is a second seam 79. In this regard, the first auxiliary pad 78 is understood to bend about the first seam 77 in order to conform to a first half of the back or abdomen of the wearer, the second auxiliary pad 80 is understood to bend about the second seam 79 to conform to a second half of the back or abdomen of the wearer.

Attached to the second auxiliary pad 80 is a primary belt 82 that is attached to a male buckle element 84 including an adjustment loop 86. Again, it is understood that the length of the primary belt 82 is adjustable by threading various lengths through the adjustment loop 86. The male buckle element 84 is removably engageable to a female buckle element 88 that is attached to a secondary belt 90. The secondary belt 90, in turn, is attached to the first auxiliary pad 78. The female buckle element 88 also includes an adjustment loop 86, through which the secondary belt 90 is threaded. As such, the lengths of the primary belt 82 and the secondary belt 90 are both adjustable. The primary belt 82 and the secondary belt 90, which are interlocked to each other, extends around the remaining part of the wearer (in back carry, the primary belt 82 and the secondary belt 92 abut against the abdomen, while in front carry, the primary belt 82 and the secondary belt 92 abut against the lower back). It is contemplated that, along with the secondary support panel 30, the primary belt 82 and the secondary belt 92 assist in the even distribution of the load of the occupant for added comfort.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. An infant carrying apparatus for carrying an infant, the infant carrying apparatus comprising:
a support panel having a top end portion, an opposed bottom end portion, and a midsection disposed between the top end portion and the bottom end portion, the midsection defining a pair of opposed midsection side portions;
a pair of shoulder harnesses coupled to the top end portion of the support panel; and
a pair of lateral infant restraints, each lateral infant restraint extending between a respective one of the pair of midsection side portions and a respective one of the pair of shoulder harnesses;
the support panel, the pair of shoulder harnesses and the pair of lateral infant restraints collectively defining a pair of leg openings sized and configured to receive respective ones of the legs of the infant.

2. The infant carrying apparatus of claim 1, wherein each lateral infant restraint includes a padded leg support coupled to the support panel and an adjustable connector strap connectable to the padded leg support and connected to a respective one of the pair of shoulder harnesses.

3. The infant carrying apparatus of claim 2, further comprising a pair of first connector elements and a pair of second connector elements, each first connector element being coupled to a respective padded leg support, each second connector element being coupled to a respective adjustable connector strap, each second connector element being detachably engageable with a respective one of the pair of first connector elements to couple the respective padded leg support to the respective adjustable connector strap.

4. The infant carrying apparatus of claim 3, wherein each padded leg support includes a leg support pocket sized to receive the first connector element.

5. The infant carrying apparatus of claim 3, wherein the first and second connector elements are complimentary male and female connectors.

6. The infant carrying apparatus of claim 1, wherein the support panel includes a primary support panel including the top end portion, opposed bottom end portion and the midsection, and a secondary support panel fixed to the bottom end portion of the primary support panel.

7. The infant carrying apparatus of claim 6, wherein each shoulder harness is additionally coupled to the secondary support panel.

8. The infant carrying apparatus of claim 6, further comprising:
a support belt extended through the secondary support panel, the support belt defining a first connector end engageable to an opposed second connector end to maintain a looped configuration.

9. The infant carrying apparatus of claim 1 wherein each of the shoulder harnesses defines a flexible top end portion and a padded middle portion.

10. The infant carrying apparatus of claim 1, further comprising a harness support member extending between the pair of shoulder harnesses.

11. The infant carrying apparatus of claim 10, wherein the harness support member includes a first strap fixed to a first one of the pair of shoulder harnesses and a second strap fixed to a second one of the pair of shoulder harnesses, the first strap including a first buckle engageable to a second buckle of the second strap.

12. An infant carrying apparatus for carrying an infant, the infant carrying apparatus comprising:
a primary support panel having a top end portion, an opposed bottom end portion, and a midsection disposed between the top end portion and the bottom end portion;
a secondary support panel fixed to the bottom end portion of the primary support panel;
a pair of shoulder harnesses, each support harness being coupled to the top end portion of the support panel and to the secondary support panel; and
a support belt extended through the secondary support panel, the support belt defining a first connector end engageable to an opposed second connector end to maintain a looped configuration.

13. The infant carrying apparatus of claim 12, further comprising a harness support member extending between the pair of shoulder harnesses.

14. The infant carrying apparatus of claim 12, further comprising:
a pair of lateral infant restraints, each lateral infant restraint extending between a respective one of the midsection side portions and a respective one of the pair of shoulder harnesses;
the primary support panel, the secondary support panel, the pair of shoulder harnesses and the pair of lateral infant restraints collectively defining a pair of leg openings sized and configured to receive respective ones of the legs of the infant.

15. The infant carrying apparatus of claim 14, wherein each lateral infant restraint includes a padded leg support coupled to the support panel and an adjustable connector strap connectable to the padded leg support and connected to a respective one of the pair of shoulder harnesses.

16. The infant carrying apparatus of claim 15, further comprising a pair of first connector elements and a pair of second connector elements, each first connector element being coupled to a respective padded leg support, each second connector element being coupled to a respective adjustable connector strap, each second connector element being detachably engageable with a respective one of the pair of first connector elements to couple the respective padded leg support to the respective adjustable connector strap.

17. The infant carrying apparatus of claim 16, wherein each padded leg support includes a leg support pocket sized to receive the first connector element.

18. The infant carrying apparatus of claim 16, wherein the first and second connector elements are complimentary male and female connectors.

19. The infant carrying apparatus of claim 12, further comprising:
a support belt extended through the secondary support panel, the support belt defining a first connector end engageable to an opposed second connector end to maintain a looped configuration.

20. The infant carrying apparatus of claim 12 wherein each of the shoulder harnesses defines a flexible top end portion and a padded middle portion.
